(19) United States
(12) Patent Application Publication
(10) Pub. No.: US 2006/0154096 A1
(43) Pub. Date: Jul. 13, 2006

(54) Method for applying and forming a film produced from a filmogen polymer aqueous dispersion on a surface based on a still humid mineraal binder compound, the thus coated mineral binder compounds and the use thereof

(76) Inventors: Daniel Joubert, Vineuil Saint Firmin (FR); Francois Sanchez, Le Blanc Mesnil (FR)

Correspondence Address: Jean-Louis Seugnet;Rhodia Inc, 259 Propect Plains Road, CN 7500, Cranbury, NJ, 08512, US

(21) Appl. No.: 10/559,642

(22) PCT Filed: Jun. 3, 2004
(86) PCT No.: PCT/FR04/01377

§ 371 Date: Dec. 2, 2005

(30) Foreign Application Priority Data
Jun. 5, 2003 (FR) 03/06796

(51) Int. Cl. B32B 27/00; B05D 3/02

(52) U.S. Cl. 428/500; 427/372.2

(57) ABSTRACT

The invention relates a method for applying a finish coat, for example in the form of a paint or varnish on a surface based on a still humid mineral binder compound. Said invention relates, in particular to mineral binder compounds in the form of mould parts and prefabricated elements for construction, civil engineering or public works. It is possible to give an example of mould parts or prefabricated construction elements embodied in the form of cement or concrete tiles, said cement or concrete being reinforced or not by fibers, gypsum board liners, mould fiber cement elements or gypsum plasterboards.

The present invention relates to a method of applying a finish coat such as, for example, a paint or a varnish to a surface based on a mineral binder composition while it is still wet. This relates in particular to mineral binder compositions in the form of moldings or prefabricated components for the construction industry, civil engineering or public works.

Examples of moldings or prefabricated components for the construction industry that may be mentioned include cement or concrete tiles, the cement or concrete possibly being fiber-reinforced, cladding panels, fiber cement panels or molded components made of fiber cement, or plasterboards.

Very schematically, the process for manufacturing a molding or prefabricated part based on a mineral binder composition comprises the following steps:

Step 1: preparation of the hydraulic mineral binder composition by mixing, in aqueous phase, hydraulic binder optionally with mineral fillers, cellulose fibers, polyvinyl alcohol, mineral pigments (metal oxides), and optionally filtering so as to obtain a cake;

Step 2: molding of the still malleable cake obtained from step 1;

Step 3: deposition of a finish coat such as a paint or a varnish on the molded cake from step 2; and

Step 4: thermal cure for consolidating the cake obtained in step 3.

The finish coat of step 3 may be a paint or a varnish, most particularly if the hydraulic binder composition contains bulk-mixed pigments.

The paint or varnish used may be in a solvent phase or in the form of an aqueous film-forming polymer dispersion (latex).

When the paint or varnish is in a solvent phase, there is no particular technical difficulty. However, for environmental reasons, it is preferable to avoid using solvents, and the profession of course seeks to replace the solvent-based paint or varnish with aqueous film-forming polymer dispersions.

Now, one technical problem arises in order to deposit and form a film coming from an aqueous film-forming polymer emulsion on a mineral-binder-based surface while it is still wet, with free water on the surface, comprising soluble mineral salts and alkalis extracted from the mineral binder. This is because the aqueous phases of the still fresh mineral binder (such as cement) and of the latex are miscible, and this results in the migration and diffusion of these soluble salts from the mineral binder into the aqueous film-forming polymer dispersion during the film formation phase and the film consolidation phase.

The predictable drawbacks are of course poor film formation by “obstacle” to coalescence, and, during aging, destructuring of the film, and even its incorporation into the mineral binder slurry in the most extreme cases, or else mineral bloom appearing on the outer surface of the paint or varnish, with the creation of unprotected hydrophilic regions and possible impairment of the molding painted or varnished according to the method described above when said molding is exposed to the weather.

Film formation may be even more difficult when the temperature is lower, especially during winter when the temperatures in the manufacturing unit may be below 10° C., or even negative. To prevent problems of finished tiles “bonding” to one another when being stored (stacked tiles) and also to prevent them getting dirty in use, latices of high glass transition temperature (T_{g}) of around 30 to 60° C. are used. Under these conditions, in order to lower the minimum film-forming temperature MFFT, and even to make film formation possible, volatile organic coalescants or plasticizers (VOCs) have to be added to the latex, this obviously being harmful to the environment.

There is a need to find a means of depositing and forming a film coming from an aqueous film-forming polymer emulsion on a surface based on a mineral binder while it is still wet that does not have the above-mentioned drawbacks of the prior art and that provides a high-quality coating under all operating conditions, while reducing as far as possible the use of volatile organic compounds.

The subject of the present invention is therefore a method for depositing and forming a film coming from an aqueous film-forming polymer emulsion on a surface based on a mineral binder composition while it is still wet, characterized in that a sufficient quantity of at least one water-soluble amphiphilic copolymer is added to said aqueous film-forming polymer emulsion, the water-soluble amphiphilic copolymer being selected from:

(i) at least one polymer obtained by the polymerization
of at least one ethylenically unsaturated monomer (I) of monocarboxylic or polycarboxylic acid type, or else a precursor of carboxylic acids of anhydride type, whether aliphatic, cyclic, linear or branched, and
of at least one linear or branched, monoethylenically unsaturated hydrocarbon monomer (II), this hydrocarbon monomer not being aromatic;

(ii) at least one polymer coming from the polymerization of at least one monocarboxylic or poly-carboxylic acid monomer (I), or anhydride, whether aliphatic, cyclic, linear or branched, which is ethylenically unsaturated and includes at least one hydrophobic, saturated or unsaturated, C₄-C₃₀ hydrocarbon grafted species, optionally interrupted by one or more heteroatoms, this hydrophobic grafted species not being aromatic; and

(iii) at least one polymer obtained by chemical modification such as for example by esterification, transesterification or amidification of a precursor polymer comprising, on the one hand, sites on which a hydrophobic species can be grafted, such as for example carboxylic acid or ester sites, this hydrophobic grafted species not being aromatic and comprising, moreover, carboxylic acid units or carboxylic acid precursors.

The mineral binders may be selected from hydraulic binders and air-setting binders.

A hydraulic binder within the context of the present invention is a binder that causes setting to take place upon contact with water and that, once hardened, is no longer sensitive to water. Examples of hydraulic binders that may be mentioned include cements, which may be of the Portland, aluminous or blast-furnace slag type.

An air-setting binder within the context of the present invention is a binder that causes setting to take place upon contact with water and that, once hardened, remains sensitive to water. Examples of air-setting binders that may be mentioned include plasters.

Other compounds, often added as mineral additives to the cement, also have hydraulic properties, such as fly ash, calcined schists and natural or synthetic pozzolana. These mineral additives, called pozzolanic compounds, react with lime and form hydrated calcium silicates.

When the mineral binders are hydraulic mineral binders, they are generally based on cement. They may be in the form of slurries or concretes. They are used for example in the following applications: monolayer coatings, outdoor thermal insulation systems, leveling and finishing coats, repair mortars or impermeable membranes.

When the mineral binders are air-setting mineral binders, they are generally plaster-based.

Preferably, the mineral binders of the invention are in the form of moldings or prefabricated components for the construction industry, civil engineering or public works.

As examples, mention may be made of cement tiles, the cement possibly being fiber-reinforced, cladding panels, fiber cement panels or molded components made of fiber cement, or plasterboards.

The paint or varnish is in the form of an aqueous dispersion of a water-insoluble film-forming polymer (latex).

The preferred water-insoluble film-forming polymers are obtained by the polymerization of monomers selected from:

vinyl esters and more particularly vinyl acetate;

alkyl acrylates and methacrylates, the alkyl group of which contains 1 to 10 carbon atoms, for example methyl, ethyl, n-butyl and 2-ethylhexyl acrylates and methacrylates; and

vinylaromatic monomers, particularly styrene.

These monomers may be copolymerized with themselves or with other ethylenically unsaturated monomers, in order to form homopolymers, copolymers or terpolymers.

Nonlimiting examples of monomers that can be copolymerized with vinyl acetate and/or acrylic esters and/or styrene that may be mentioned include ethylene and olefins such as isobutene; vinyl esters of branched or unbranched, saturated monocarboxylic acids having from 1 to 12 carbon atoms, such as vinyl propionate, vinyl “Versatate” (registered trademark for esters of C₉-C₁₁ branched acids), vinyl pivalate and vinyl laurate; esters of monocarboxylic or dicarboxylic unsaturated acids having 3 to 6 carbon atoms with alkanols having 1 to 10 carbon atoms, such as methyl, ethyl, butyl and ethylhexyl maleates and fumarates; vinylaromatic monomers, such as methylstyrenes and vinyltoluenes; vinyl halides, such as vinyl chloride and vinylidene chloride; diolefins, particularly butadiene; (meth)allylic esters of (meth)acrylic acid; (meth)allylic esters of monoesters and diesters of maleic, fumaric and itaconic acids; and alkene derivatives of amides of acrylic and methacrylic acids, such as N-methallylmaleimide.

At least two copolymerizable monomers of different types may in particular be selected in order to obtain a terpolymer.

One example that may be mentioned is an acetate/versatate/dibutylmaleate-type terpolymer.

In general, the paints or varnishes used are acrylic paints or varnishes, that is to say they comprise polymers based on acrylic-type monomers (such as alkyl acrylates and methacrylates, the alkyl group of which contains 1 to 10 carbon atoms, for example methyl, ethyl, n-butyl and 2-ethylhexyl acrylates and methacrylates). They may also include other monomers. They may for example be styrene-acrylic varnishes. However, in the intended applications, “pure” acrylic paints or varnishes, that is to say those based on only acrylic-type monomers, are preferred.

The latices used are selected in such a way that their glass transition temperature (T_{g}) is between 0 and 60° C. and preferably between 30 and 60° C. This prevents the molded objects when coated sticking together during storage phases. Optionally, the aqueous film-forming polymer dispersions may include plasticizers, so as to reduce the minimum film formation temperature (MMFT) when the method of the invention is carried out at very low temperatures, that is to say at temperatures below 0° C.

As indicated above, the water-soluble amphiphilic copolymer that is added to the aqueous film-forming polymer dispersion is selected from:

(i) at least one polymer obtained by the polymerization
of at least one ethylenically unsaturated monomer (I) of monocarboxylic or polycarboxylic acid type, or else a precursor of carboxylic acids of anhydride type, whether aliphatic, cyclic, linear or branched, and
of at least one linear or branched, monoethylenically unsaturated hydrocarbon monomer (II), this hydrocarbon monomer not being aromatic;

(ii) at least one polymer resulting from the polymerization of at least one monocarboxylic or poly-carboxylic acid monomer (I), or anhydride, whether aliphatic, cyclic, linear or branched, which is ethylenically unsaturated and includes at least one hydrophobic, saturated or unsaturated, C₄-C₃₀ hydrocarbon grafted species, optionally interrupted by one or more heteroatoms, this hydrophobic grafted species not being aromatic; and

(iii) at least one polymer obtained by chemical modification such as for example by esterification, transesterification or amidification of a precursor polymer comprising, on the one hand, sites on which a hydrophobic species can be grafted, such as for example carboxylic acid or ester sites, this hydrophobic grafted species not being aromatic and comprising, moreover, carboxylic acid units or carboxylic acid precursors.

According to one particular embodiment of the first variant (i), mention may firstly be made of polymers resulting from the polymerization:

of at least one monomer (I) having the following formula:
(R¹)(R¹)C═C(R′¹)—COOH (I)
in which formula:

the radicals R¹, R′¹, which are the same or different, represent a hydrogen atom, a C₁-C₁₀ hydro-carbon radical optionally containing a —COOH group, a —COOH group; and

of at least one monomer of formula (II) having the following formula:
(R²) (R³)C═C(R⁵)(R⁶) (II)
in which formula:

the radical R² represents a hydrogen atom, a C₁-C₁₀, linear or branched, alkyl radical optionally substituted with heteroatoms;

the radical R³ represents a C₁-C₁₀, linear or branched, alkyl radical optionally substituted with heteroatoms, or an —OR⁴ radical, that is to say a vinyl ether, where R⁴ represents a C₁-C₁₀, linear or branched, alkyl radical optionally substituted with heteroatoms;

the radical R⁵ represents a hydrogen atom or a C₁-C₁₀, linear or branched, alkyl radical optionally substituted with heteroatoms; and

the radical R⁶ represents a hydrogen atom or a C₁-C₁₀, linear or branched, alkyl radical optionally substituted with heteroatoms,

it being understood that at least one of the radicals R², R³, R⁵ or R⁶ represents a C₁-C₁₀, linear or branched, alkyl radical optionally substituted with heteroatoms.

According to a preferred embodiment of the invention, the monomer of formula (I) is such that one of the radicals R¹ is a hydrogen atom; the other radical R¹ represents a hydrogen atom, a —COOH group or a —(CH₂)ₙCOOH group in which n is between 1 and 4, or a C₁-C₄ alkyl radical; R′¹ represents a hydrogen atom, a —(CH₂)ₘCOOH group in which m is between 1 and 4, or a C₁-C₄ alkyl radical. Preferably, one of the radicals R¹ represents a hydrogen atom, the other radical R¹ represents a hydrogen atom, a —COOH or (CH₂)COOH group or a methyl radical, and R′¹ represents a hydrogen atom, a —CH₂COOH group or a methyl radical.

According to one more particular embodiment, the monomer of formula (I) is selected from acrylic, methacrylic, citraconic, maleic, fumaric, itaconic and crotonic acids or anhydrides.

Even more preferably, the monomer of formula (I) is selected from maleic anhydride.

As regards the monomer of formula (II), this may especially be selected from ethylene, propylene, 1-butene, isobutylene, n−1-pentene, 2-methyl-1-butene, n-1-hexene, 2-methyl-1-pentene, 4-methyl-1-pentene, 2-ethyl-1-butene, diisobutylene (or 2,4,4-trimethyl-1-pentene), 2-methyl-3,3-dimethyl-1-pentene or, in the case of vinyl ethers, selected from isobutyl vinyl ether, methyl vinyl ether, 1-menthyl vinyl ether, phenyl vinyl ether and octadecyl vinyl ether.

Preferably, the copolymer of formula (i) results from the polymerization of maleic anhydride and isobutylene.

It should be mentioned that the polymer (i) is obtained more particularly by carrying out a radical polymerization of the monomers (I) and (II).

These compounds are well known to those skilled in the art. Examples of polymers of this type that may be mentioned include those sold under the name Geropon® T36 (maleic anhydride/diisobutylene copolymer) by Rhodia Chimie, Sokalan® CP9 (maleic anhydride/olefin copolymer) sold by BASF and Gantrez resins sold by ISP.

In general, the sufficient amount of water-soluble amphiphilic copolymer added to the aqueous film-forming polymer dispersion (latex) is between 0.3 and 5% by weight of dry water-soluble amphiphilic copolymer relative to the weight of dry latex.

Preferably, the sufficient amount of water-soluble amphiphilic copolymer added to the aqueous film-forming polymer dispersion (latex) is between 0.5 and 3% by weight of dry water-soluble amphiphilic copolymer relative to the weight of dry latex.

Even more preferably, the sufficient amount of water-soluble amphiphilic copolymer added to the aqueous film-forming polymer dispersion (latex) is between 0.5 and 1.5% by weight of dry water-soluble amphiphilic copolymer relative to the weight of dry latex.

The addition of water-soluble amphiphilic copolymer must of course be suitably metered for both economic and technical reasons. Since the amphiphilic copolymer is a water-soluble product, it should not be in excess relative to the amount needed to cover the surface of the wet cement with a monomolecular layer. If it is in excess, it may then exude, or impair the proper behavior of the film.

The water-soluble amphiphilic copolymer may be added by the addition of a solid powder of the water-soluble amphiphilic copolymer or else by the addition of an aqueous solution of this water-soluble amphiphilic copolymer to the aqueous film-forming polymer dispersion (latex), that is to say a liquid/liquid mixture. It is this second embodiment that is preferred.

The water-soluble amphiphilic copolymer solutions are prepared in such a way that the water-soluble amphiphilic copolymer is dissolved in water and a base, such as for example aqueous ammonia, monoethanolamine, sodium hydroxide and/or potassium hydroxide, is added at temperatures ranging from 20° C. to 100° C. Preferably, the finished solutions have a pH>8. For example, if the water-soluble amphiphilic copolymer used is Geropon T36, it is possible to use Geropon T36 DF, which is a solution containing 25% of active substance, the pH of which at 10% in water is between 10 and 11.5.

The water-soluble amphiphilic copolymer and the aqueous film-forming polymer dispersion may be mixed by liquid/liquid mixing in any liquid/liquid mixer for mixing without introducing air.

The composition of the invention, comprising the mixture of the water-soluble amphiphilic copolymer of the invention and the aqueous film-forming polymer dispersion, may be applied to the wet surface of the mineral binder composition by being sprayed, rolled or brushed thereonto, or by any other known techniques.

The subject of the present invention is also a mineral binder composition, the surface of which is at least partly covered with a film resulting from the drying of a composition comprising an aqueous film-forming polymer emulsion and at least one water-soluble amphiphilic copolymer.

The mineral binders of the invention are preferably in the form of moldings or prefabricated components for the construction industry, civil engineering or public works.

Examples that may be mentioned include cement tiles, the cement possibly being fiber-reinforced, cladding panels, fiber cement panels or molded components made of fiber cement, or plasterboards.

### 1—EXAMPLES

### Example 1

Method of manufacturing concrete tiles:

Manufacture of the tile body: The tile body was obtained by a technique of the “fiber cement” type: a dilute aqueous slurry (about 200 g/l) comprising cement, CaCO₃-type mineral fillers, a mixture of cellulose fibers and polyvinyl alcohol fibers, various additives and optionally mineral pigments (metal oxides) was filtered over a drum filter. This technique, similar to a papermaking technique, allowed a cake to be produced, consisting of a multilayer for having the required final thickness;

This still malleable cement cake was molded. It was also possible to deposit a concentrated cement slurry containing no fibers on the visible part of the tile, so as to bond to the fibers exposed on the surface of the tile body and to make them disappear;

This molded cake was coated with a finish coat, this being an acrylic varnish; and

This molded and varnished cake then underwent a thermal consolidation cure.

Trials carried out in Australia showed results of random quality, in particular depending on the season and the temperature at the time of manufacture. In hot weather, the problem seems to be solved and the Australian product from Box Hill, Duramul D 641, a pure acrylic with a T_{g} of about 30° C., is satisfactory. However, in winter, the temperatures in the production units may be below 10° C., and under these conditions the results obtained were poor. This is because film formation was retarded by the excessively low temperature (slower evaporation of the water of the aqueous film-forming polymer dispersion), while the water of the fresh cement and the water of the aqueous film-forming polymer dispersion had more time to mix together and so create the abovementioned problems, that is to say poor film formation by “obstacle” to coalescence, and, during aging, destructuring of the film, and even its incorporation into the mineral binder slurry in the most extreme cases, or else mineral bloom appearing on the outer surface of the paint or varnish, with the creation of unprotected hydrophilic regions and possible impairment of the molding painted or varnished according to the method described above when said molding is exposed to the weather.

We have undertaken a series of various application tests in order to try to solve this problem, caused by what may be termed an “undefined miscible interface” effect, by developing a suitable latex emulsion that consists in modifying the Duramul or mixing additives thereto so as to make it operative in all cases.

We therefore tested a series of additives, added to the Duramul at low doses, under conditions reproducing the wet-on-wet technique.

### 2—DEFINITION OF THE TESTS

First of all, we defined several levels of tests, consisting in depositing the Duramul or additive-modified Duramul latices to a cement surface at various stages in its hydration and crystallization process. The test adopted was the following, this representing the most difficult processing conditions, in which the cement was in the least hydrated state and/or a continuous water film was forming on the upper surface. A cement slurry having the following composition was prepared:

| | | |
|---|---|---|
| Water | 21% | by weight relative to the |
| | | total weight of the mix |
| Portland cement CPA52.5 | 38% | by weight relative to the |
| | | total weight of the mix |
| Sifraco EN 31 sand | 38% | by weight relative to the |
| | | total weight of the mix |
| Iron oxide (pigment) | 3% | by weight relative to the |
| | | total weight of the mix |

The slurry was poured into impressions of dimensions 10×30×6 mm in a silicon mold. These were left to rest for 5 minutes and then a specified quantity of the latex or additive-modified latex to be tested was sprayed onto this surface. To do this, a sprayer for spraying a liquid product was used with a pressurization system, and the sprayer was weighed before and after application to the cement surface.

The results were assessed by visual examination of the state of the surface after drying and by a delamination test carried out on the film formed. The state of the film, its continuity or discontinuity and its water resistance were also noted.

The phenomenon of lime bloom was visually assessed more sensitively by depositing a few drops of an aqueous acid solution, for example 5 g/l of H₂SO₄, onto the surface. The appearance of surface gas microevolution (gas bubbles) conclusively demonstrated that calcium carbonate, the predominant component of lime bloom, was present on the surface.

Finally, and above all, visual examinations were continued on test pieces after prolonged aging, such as for example 5 months, under ambient conditions, namely temperature between 20-25° C. and relative humidity between 30 and 70% HR (cf. photographs appended hereto).

This point is important as relatively slow film destructuring phenomena occur and allow the advanced solutions to be clearly differentiated.

### 3—TYPE OF ADDITIVES TESTED

Several additives (their level of addition varying between 1 and 3%) were added to a Duramul D641 aqueous film-forming polymer dispersion using a Rayneri laboratory mixer operating at low speed (about 150 rpm) so as not to include air bubbles in the mixture.

Composition of the Latex (Duramul D641), Used in all the Examples

| | | |
|---|---|---|
| Methyl methacrylate: | 60% | by weight relative to the |
| | | total weight of the mixture |
| Ethyl acrylate: | 11% | by weight relative to the |
| | | total weight of the mixture |
| Butyl acrylate: | 28% | by weight relative to the |
| | | total weight of the mixture |
| Methacrylic acid: | 1% | by weight relative to the |
| | | total weight of the mixture |
| Solids content (SC) | 49% | by weight relative to the |
| | | total weight of the mixture |

Composition of Geropon T36—an Example of an Additive According to the Invention—Sold by Rhodia

Random alternating copolymer obtained by copolymerization of an equimolar mixture of maleic anhydride and isobutylene—an amphiphilic copolymer. In practice, a Geropon T36 DF solution containing 25% of active substance, the pH of which at 10% in water was between 10 and 11.5, was used.

Composition of Bevaloid 6857—an Additive Tested as a Comparative Example—Sold by Rhodia

This is a water-soluble acrylic-based random copolymer having the following composition:

| | | |
|---|---|---|
| Butyl acrylate: | 60% | by weight relative to the |
| | | total weight of the mixture |
| Styrene: | 15% | by weight relative to the |
| | | total weight of the mixture |
| Methacrylic acid: | 25% | by weight relative to the |
| | | total weight of the mixture |
| SC: | 20% | by weight relative to the |
| | | total weight of the mixture |

The copolymer was neutralized with aqueous ammonia (bringing the pH upon drying back to pH 7-8). An amphiphilic copolymer.

Composition of Bevaloid 9—an Additive Tested as Comparative Example—Sold by Rhodia

Copolymer of carboxylic acids (methacrylic acid and maleic acid in anhydride form)—a nonamphiphilic product.

Composition of Rhodoline 226/35—an Additive Tested as Comparative Example—Sold by Rhodia

Copolymer of carboxylic acids (methacrylic acid and acrylic acid)—a nonamphiphilic product. Molecular weight 3500 g/mol.

Composition of Sopronyl AR10—an Additive Tested as Comparative Example—Sold by Rhodia

Copolymer of carboxylic acids (methacrylic acid and acrylic acid)—a nonamphiphilic product. Molecular weight 10 000 g/mol.

### 4—RESULTS OF THE TESTS: TABLE I

The test was the most difficult to pass, having a moving layer of water on the surface of the test piece to be coated.

Bevaloid 6857, containing styrene among the monomers, was added to the Duramul in an amount of 1% and gave results that were better than the control, but insufficient.

The same additive added at a 3% level gave no positive result.

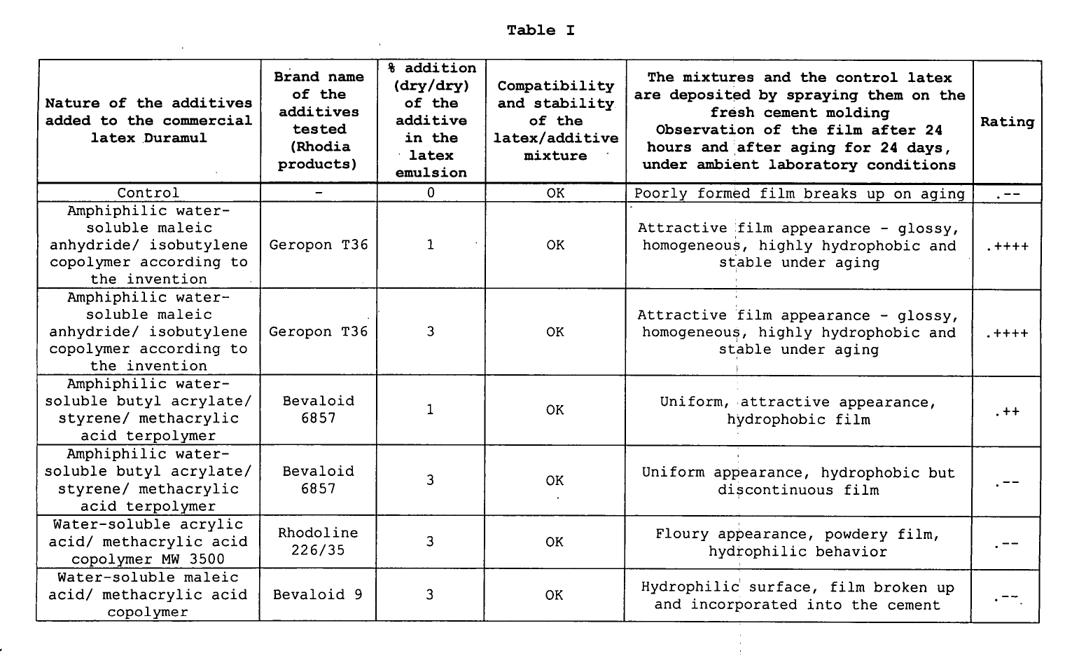

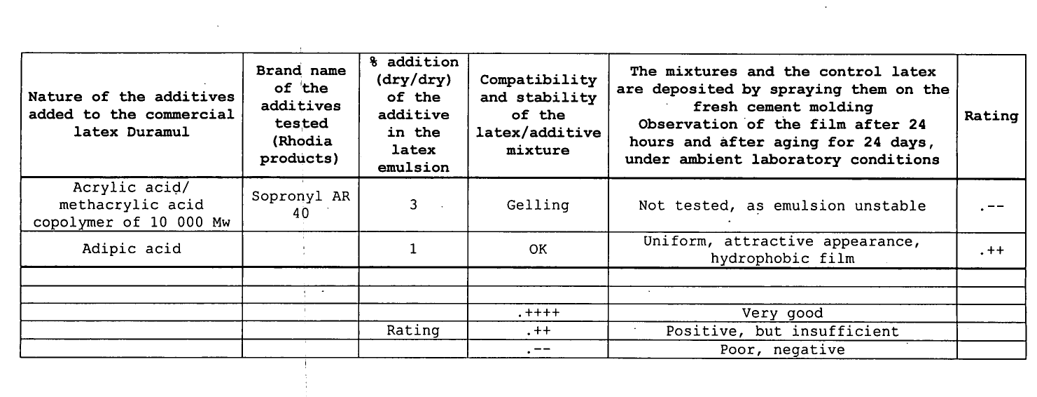

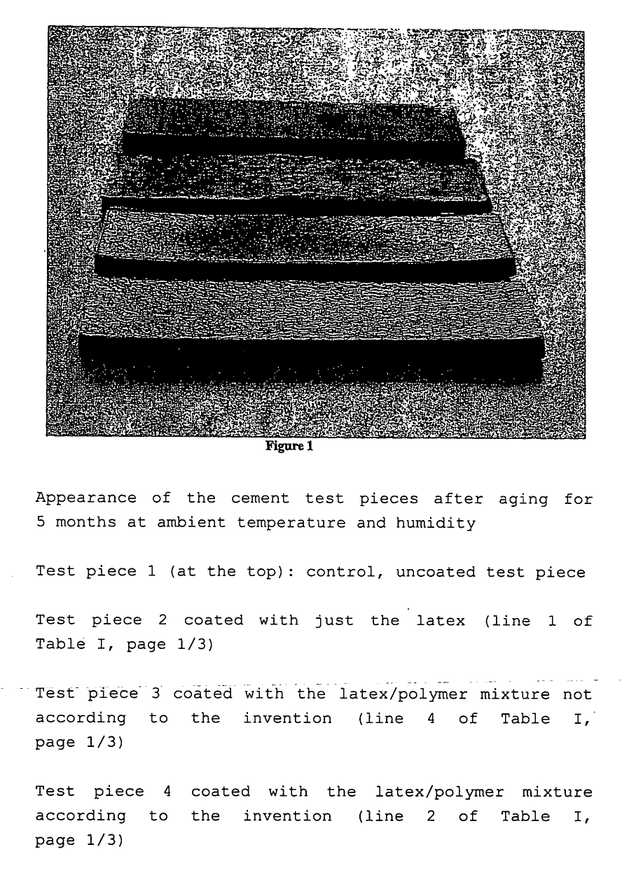

Geropon T36 gave very satisfactory results (see FIG. 1 and Table I) both at 1% and 3% by weight of dry Geropon T36 relative to the weight of dry Duramul latex.

The other products tested were not operative.

1-24. (canceled)

25. A method for depositing and forming a film coming from an aqueous film-forming polymer dispersion on a surface based on a mineral binder composition while it is still wet, wherein a sufficient quantity of at least one water-soluble amphiphilic copolymer is added to said aqueous film-forming polymer dispersion, the water-soluble amphiphilic copolymer being selected from the group consisting of:
(i) at least one polymer obtained by the polymerization
of at least one ethylenically unsaturated monomer (I) of monocarboxylic or polycarboxylic acid, or else a precursor of carboxylic acids of anhydride, whether aliphatic, cyclic, linear or branched, and
of at least one linear or branched, mono-ethylenically unsaturated hydrocarbon monomer (II), this hydrocarbon monomer not being aromatic;
(ii) at least one polymer coming from the polymerization of at least one monocarboxylic or polycarboxylic acid monomer (I), or anhydride, whether aliphatic, cyclic, linear or branched, which is ethylenically unsaturated and includes at least one hydrophobic, saturated or unsaturated, C₄-C₃₀ hydrocarbon grafted species, optionally interrupted by one or more heteroatoms, this hydrophobic grafted species not being aromatic; and
(iii) at least one polymer obtained by chemical modification of a precursor polymer comprising, on the one hand, sites on which a hydrophobic species can be grafted, this hydrophobic grafted species not being aromatic and comprising, moreover, carboxylic acid units or carboxylic acid precursors.

26. The method as claimed in claim 25, wherein the chemical modification for polymer (iii) is esterification, transesterification or amidification and the sites on which the hydrophobic species can be grafted are carboxylic acid or ester sites

27. The method as claimed in claim 25, wherein the mineral binders are hydraulic binders or air-setting binders, optionally in the form of slurries or concretes.

28. The method as claimed in claim 27, wherein the hydraulic mineral binders are plasters or cements, optionally Portland, aluminous or blast-furnace slag.

29. The method as claimed in claim 27, wherein the mineral binders are selected from fly ash, calcined schists and natural or synthetic pozzolana.

30. The method as claimed in claim 25, wherein the mineral binders are in the form of moldings or prefabricated components for the construction industry, civil engineering or public works.

31. The method as claimed in claim 30, wherein the moldings or prefabricated components are cement tiles, the cement, optionally fiber-reinforced, cladding panels, fiber cement panels, molded components made of fiber cement, or plasterboards.

32. The method as claimed in claim 25, wherein the aqueous film-forming polymer dispersion (latex) comprises at least one water-insoluble polymer obtained by the polymerization of monomers selected from:
vinyl esters optionally vinyl acetate;
alkyl acrylates and methacrylates, the alkyl group of which contains 1 to 10 carbon atoms; and
vinylaromatic monomers, optionally styrene;
these monomers being able to be copolymerized with themselves or with other ethylenically unsaturated monomers that can be copolymerized with vinyl acetate and/or acrylic esters and/or styrene, in order to form homopolymers, copolymers or terpolymers.

33. The method as claimed in claim 32, wherein the monomers that can be copolymerized with vinyl acetate and/or acrylic esters and/or styrene are selected from the group consisting of olefins; vinyl esters of branched or unbranched, saturated monocarboxylic acids having from 1 to 12 carbon atoms, esters of monocarboxylic or dicarboxylic unsaturated acids having 3 to 6 carbon atoms with alkanols having 1 to 10 carbon atoms; vinylaromatic monomers; vinyl halides, diolefins; (meth)allylic esters of (meth)acrylic acid, (meth)allylic esters of monoesters and diesters of maleic, fumaric and itaconic acids, and alkene derivatives of amides of acrylic and methacrylic acids.

34. The method as claimed in claim 33, wherein the monomers that can be copolymerized with vinyl acetate and/or acrylic esters and/or styrene are ethylene, isobutene; vinyl propionate, vinyl “Versatate” (registered trademark for esters of C₉-C₁₁ branched acids), vinyl pivalate, vinyl laurate; methyl, ethyl, butyl and ethylhexyl maleates and fumarates; methylstyrene, vinyltoluene; vinyl chloride and vinylidene chloride, butadiene; or N-methallylmaleimide.

35. The method as claimed in either of claim 33, wherein the aqueous film-forming polymer dispersion (latex) comprises at least one water-insoluble polymer obtained by the polymerization of monomers which are alkyl acrylates or methacrylates, the alkyl group of which contains 1 to 10 carbon atoms, optionally methyl, ethyl, n-butyl and 2-ethylhexyl acrylates or methacrylates.

36. The method as claimed in claim 25, wherein, in variant (i):
the monomer (I) has the following formula:
(R¹)(R¹)C═C(R′¹)—COOH (I)
in which formula:
the radicals R¹, R′¹, which are the same or different, represent a hydrogen atom, a C₁-C₁₀ hydrocarbon radical optionally containing a —COOH group, a —COOH group; and
the monomer of formula (II) has the following formula:
(R²)(R³)C═C(R⁵)(R⁶) (II)
in which formula:
the radical R² represents a hydrogen atom, a C₁-C₁₀, linear or branched, alkyl radical optionally substituted with heteroatoms;
the radical R³ represents a C₁-C₁₀, linear or branched, alkyl radical optionally substituted with heteroatoms, or an —OR⁴ radical, that is to say a vinyl ether, where R⁴ represents a C₁-C₁₀, linear or branched, alkyl radical optionally substituted with heteroatoms;
the radical R⁵ represents a hydrogen atom or a C₁-C₁₀, linear or branched, alkyl radical optionally substituted with heteroatoms; and
the radical R⁶ represents a hydrogen atom or a C₁-C₁₀, linear or branched, alkyl radical optionally substituted with heteroatoms,
with the proviso that at least one of the radicals R², R³, R⁵ or R⁶ represents a C₁-C₁₀, linear or branched, alkyl radical optionally substituted with heteroatoms.

37. The method as claimed in claim 36, wherein the monomer of formula (I) is such that:
one of the radicals R¹ is a hydrogen atom;
the other radical R¹ represents a hydrogen atom, a —COOH group or a —(CH₂)ₙCOOH group in which n is between 1 and 4, or a C₁-C₄ alkyl radical; and
R′¹ represents a hydrogen atom, a —(CH₂)ₘCOOH group in which m is between 1 and 4, or a C₁-C₄ alkyl radical.

38. The method as claimed in claim 37, wherein the monomer of formula (I) is such that:
one of the radicals R¹ represents a hydrogen atom;
the other radical R¹ represents a hydrogen atom, a —COOH or (CH₂)COOH group or a methyl radical; and
R′¹ represents a hydrogen atom, a —CH₂COOH group or a methyl radical.

39. The method as claimed in claim 38, wherein the monomer of formula (I) is selected from the group consisting of acrylic, methacrylic, citraconic, maleic, fumaric, itaconic, crotonic acids and anhydrides.

40. The method as claimed in claim 39, wherein the monomer of formula (I) is maleic anhydride.

41. The method as claimed in claim 36, wherein the monomer of formula (II) is ethylene, propylene, 1-butene, isobutylene, n-1-pentene, 2-methyl-1-butene, n−1-hexene, 2-methyl-1-pentene, 4-methyl-1-pentene, 2-ethyl-1-butene, diisobutylene (or 2,4,4-trimethyl-1-pentene), 2-methyl-3,3-dimethyl-1-pentene, isobutyl vinyl ether, methyl vinyl ether, 1-menthyl vinyl ether, phenyl vinyl ether or octadecyl vinyl ether.

42. The method as claimed in claim 35, wherein the copolymer of formula (i) results from the polymerization of maleic anhydride and isobutylene.

43. The method as claimed in claim 25, wherein the sufficient amount of water-soluble amphiphilic copolymer added to the aqueous film-forming polymer dispersion (latex) is between 0.3 and 5%, optionally between 0.5 and 1.5%, by weight of dry water-soluble amphiphilic copolymer relative to the weight of dry latex.

44. A mineral binder composition, the surface of which is at least partly covered with a film resulting from the drying of a composition comprising an aqueous film-forming polymer emulsion and at least one water-soluble amphiphilic copolymer, said water-soluble amphiphilic copolymer being selected from the group consisting of:
(i) at least one polymer obtained by the polymerization
of at least one ethylenically unsaturated monomer (I) of monocarboxylic or polycarboxylic acid, or else a precursor of carboxylic acids of anhydride, whether aliphatic, cyclic, linear or branched, and
of at least one linear or branched, mono-ethylenically unsaturated hydrocarbon monomer (II), this hydrocarbon monomer not being aromatic;
(ii) at least one polymer coming from the polymerization of at least one monocarboxylic or polycarboxylic acid monomer (I), or anhydride, whether aliphatic, cyclic, linear or branched, which is ethylenically unsaturated and includes at least one hydrophobic, saturated or unsaturated, C₄-C₃₀ hydrocarbon grafted species, optionally interrupted by one or more heteroatoms, this hydrophobic grafted species not being aromatic; and
(iii) at least one polymer obtained by chemical modification of a precursor polymer comprising, on the one hand, sites on which a hydrophobic species can be grafted, this hydrophobic grafted species not being aromatic and comprising, moreover, carboxylic acid units or carboxylic acid precursors.

45. The mineral binder as claimed in claim 44, wherein the chemical modification for polymer (iii) is esterification, transesterification or amidification and the sites on which the hydrophobic species can be grafted are carboxylic acid or ester sites

46. The mineral binder composition as claimed in claim 44, wherein the mineral binders are in the form of moldings or prefabricated components.

47. The mineral binder composition as claimed in claim 46, wherein the mineral binders are cement tiles, fiber-reinforced cement tiles, cladding panels, fiber cement panels, molded components made of fiber cement, or plasterboards.
